(19) United States
(12) Patent Application Publication
(10) Pub. No.: US 2022/0102737 A1
(43) Pub. Date: Mar. 31, 2022

(54) ENHANCED DURABILITY OF FUEL CELL METALLIC BIPOLAR PLATE

(71) Applicant: HYZON MOTORS INC., Honeoye Falls, NY (US)

(72) Inventors: Rajesh Bashyam, Delta (CA); Arthur E. Koschany, Yuhong Xingtian (CN)

(21) Appl. No.: 17/485,715

(22) Filed: Sep. 27, 2021

Related U.S. Application Data
(60) Provisional application No. 63/084,213, filed on Sep. 28, 2020.
(60) Provisional application No. 63/084,232, filed on Sep. 28, 2020.

(51) Int. Cl. H01M 8/0228; H01M 8/0206

(52) U.S. Cl. CPC H01M 8/0228; H01M 8/0206

(57) ABSTRACT

A metallic bipolar plate has a main body coated with an overlayer. The overlayer can include a graphite-based compound. The overlayer can also include electrically conductive oxides. The electrically conductive oxides can include a member selected from a list consisting of RuIrOₓ (Ru rich), IrRuOₓ (Ir rich), RuOₓ, NbOₓ, IrOₓ, and combinations thereof.

### CROSS-REFERENCE TO RELATED APPLICATIONS

This application claims the benefit of U.S. Provisional Application Ser. No. 63/084,213, filed on Sep. 28, 2020, and U.S. Provisional Application Ser. No. 63/084,232, filed on Sep. 28, 2020. The entire disclosures of the above applications are hereby incorporated herein by reference.

### FIELD

The present disclosure relates to fuel cells and, more particularly, bipolar plates for use in fuel cells.

### INTRODUCTION

This section provides background information related to the present disclosure which is not necessarily prior art.

Traditionally, electricity can be generated using fossil fuels. However, most scientists agree that emissions of pollutants and greenhouse gases from fossil fuel-based electricity generation account for a significant portion of world greenhouse gas emissions; in the United States, electricity generation accounts for nearly 40% of emissions, the largest of any source. Therefore, consumers and the general public are interested in other methods of producing electricity that can militate against the gas emissions generated by fossil fuel-based electricity generation. Several different methods of generating electricity have been proposed as possible substitutes, such as nuclear, geothermal, wind, tidal, and solar. Of the proposed technologies, fuel cells perhaps offer the most attractive solution for replacing fossil fuels. Fuel cells have been proposed as clean, efficient, and environmentally responsible power sources for various industries, including manufacturing centers, homes, and electric vehicles among other applications.

One example of the fuel cell is a proton exchange membrane (PEM) fuel cell. The PEM fuel cell includes a membrane electrode assembly (MEA) having a thin, solid polymer or composite membrane having anode and cathode layers (each including a catalyst) disposed on opposite faces of the membrane. The membrane can include an ionomer and can be permeable to protons. The MEA can be disposed between a pair of porous conductive materials, also known as gas diffusion media, which distribute gaseous reactants, for example, hydrogen to the anode layer and oxygen or air to the cathode layer. The hydrogen reactant is introduced at the anode where it reacts electrochemically in the presence of the catalyst to produce electrons and protons. The electrons are conducted from the anode to the cathode through an electrical circuit disposed therebetween, which can include an electrical load such as an electric motor, for example. Simultaneously, the protons pass through the membrane to the cathode where an oxidant, such as oxygen or air, reacts electrochemically in the presence of the catalyst to produce oxygen anions. The oxygen anions react with the protons to form water as a reaction product.

The MEA of the PEM fuel cell is sandwiched between a pair of electrically conductive bipolar plates which serve as current collectors for the anode and cathode layers. The bipolar plates can contain and direct fluids into, within, and out of the fuel cell, and distribute fluids (e.g., reactant fluids including hydrogen and oxygen or air, coolant) to fuel cell areas necessary for operation. Also, bipolar plates can provide structural support for diffusion media, membranes, seals, etc. Additional functions of bipolar plates can include sealing between fuel cells in a fuel cell stack, conducting heat formed by reactions within the fuel cell, and importantly conducting electricity generated by the fuel cell reactions.

Although fuel cells offer a promising alternative to fossil fuel-based electricity generation, the application of fuel cell technology to create an optimized fuel cell has proven to be difficult. For example, metallic bipolar plates have many advantages over graphite bipolar plates in terms of performance, weight, thickness, and ease of manufacturing. However, metallic bipolar plates, when exposed to water, can corrode resulting in diminished performance before the required lifespan is achieved; e.g., fuel cell components can generally target a durability of over 25,000 hours for heavy duty applications.

One method of increasing the durability of the metallic bipolar plate is to coat the metallic bipolar plate with an overlayer coating. This overlayer coating can maintain the conductivity of the bipolar plate, while militating against the surface of the bipolar plate experiencing passivation from surface oxides, where passivation can undesirably increase the resistance of the plate. However, if the overlayer coating has a pin hole, scratch, or other defect, the exposed metal substrate can be attacked and form local corrosion when exposed to water. Undesirably, the localized corrosion can propagate across the metal substrate of the bipolar plate and negatively impact performance of the plate.

Accordingly, there is a continuing needed for a metallic bipolar plate that has increased durability, while being conductive. Desirably, the metallic bipolar plate would exhibit intrinsic chemical, electrochemical, and corrosion resistance.

### SUMMARY

In concordance with the instant disclosure, a metallic bipolar plate that has increased durability, while being conductive, and which provides intrinsic chemical, electrochemical, and corrosion resistance, has been surprisingly discovered.

In one embodiment, a metallic bipolar plate has a main body. The main body can include an overlayer. The main body can be coated with the overlayer. The overlayer can include electrically conductive oxides and a graphite-based compound. The electrically conductive oxides can include one or more oxides of ruthenium (Ru), iridium (Ir), niobium (Nb), and combinations thereof. Such oxides can include a member selected from a group consisting of RuIrOₓ (Ru rich), IrRuOₓ (Ir rich), RuOₓ, NbOₓ, IrOₓ, and combinations thereof.

In another embodiment, the metallic bipolar plate has a main body. The main body can have a first overlayer and a second overlayer. The main body can be coated with the first overlayer. The first overlayer can be coated with the second overlayer. The first overlayer can include a graphite-based compound. The second overlayer can include electrically conductive oxides. The electrically conductive oxides can include a member selected from a group consisting of RuIrOₓ (Ru rich), IrRuOₓ (Ir rich), RuOₓ, NbOₓ, IrOₓ, and combinations thereof.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 illustrates a schematic, exploded perspective view of a PEM fuel cell stack, showing only two fuel cells with a single metallic bipolar plate assembly for purpose of simplicity, where the metallic bipolar plate is constructed in accordance with the present technology;

FIG. 2 is a side view of the bipolar plate of FIG. 1, showing an embodiment of the metallic bipolar plate constructed in accordance with the present technology;

FIG. 3 is a side view of the bipolar plate of FIG. 1, showing another embodiment of the metallic bipolar plate constructed in accordance with the present technology; and

FIG. 4 is a flow chart showing steps for producing the bipolar plate in accordance with the present technology.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

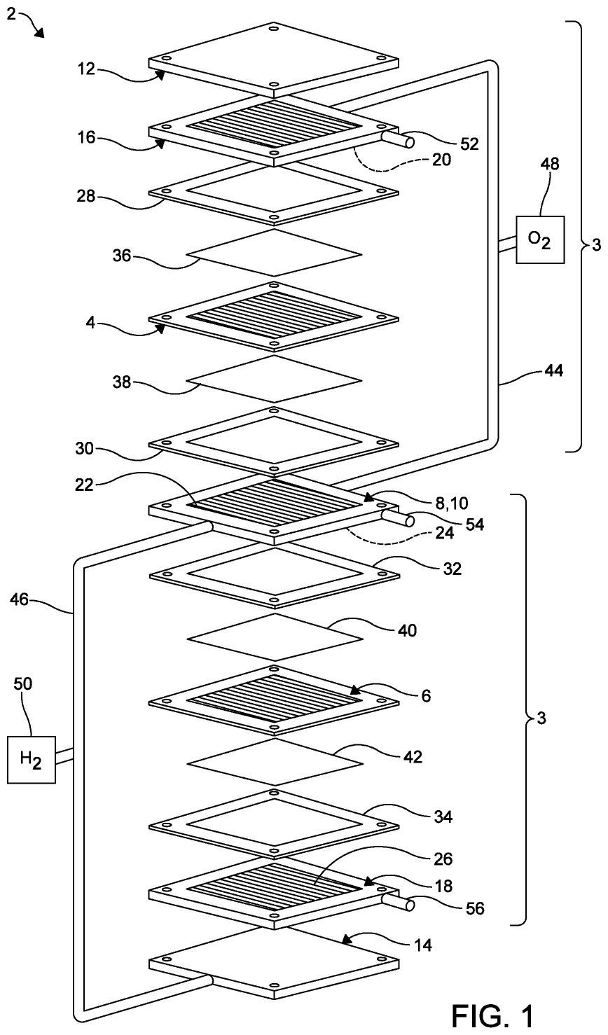

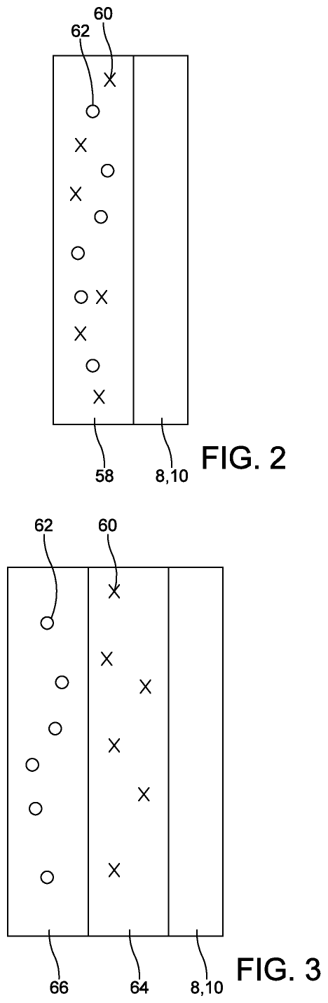

A fuel cell can include a pair of bipolar plates sandwiching a membrane electrode assembly (MEA), where certain gaskets and/or gas diffusion layers can be provided to optimize reactant distribution and localization. A non-limiting example of the general structure of a fuel cell stack including two fuel cells is shown in FIG. 1, where representations of a single fuel cell are shown in FIGS. 2-3. However, it should be appreciated that a skilled artisan can employ one or more fuel cells with different structures, within the scope of this disclosure.

The bipolar plates can be configured to surround a respective MEA and can be used to connect multiple MEAS of multiple fuel cells in series by stacking them atop or adjacent each other to provide a desired output voltage. The bipolar plates are electrically conductive and can be manufactured from metals including, but not limited to, titanium and stainless steel, carbon, and composites thereof. These bipolar plates provide electrical conduction between cells, as well as providing physical strength to the stack. It should be appreciated that one skilled in the art can employ different bipolar plates, as desired.

Each of the bipolar plates can also include a main body. The main body can have a reactant flow field. The flow field can include a set of channels machined or stamped into the plate to permit reactant fluids (e.g., hydrogen and air or oxygen) to be distributed to the MEA. It should be appreciated that one skilled in the art can employ different types of reactant flow fields, within the scope of this disclosure.

The bipolar plates can also include an overlayer. The overlayer can be applied to a portion of the bipolar plate or the entirety of the bipolar plate. The overlayer can be configured to be highly electrically conductive, while also providing chemical, electrochemical, and corrosion resistance. The overlayer can include a heterogenous composition or admixture. The admixture can be based on graphite-based compounds and transition metal oxides. The graphite-based compounds can include graphite-based oxides, graphene oxides, graphene, and combinations thereof. The transition metal oxides can include one or more oxides of ruthenium (Ru) and iridium (Ir) and surface modified variants thereof. Examples of transition metal oxides include, but are not limited to, RuIrOx (Ru rich), IrRuOx (Ir rich), RuOx/NbOx and IrOx/NbOx and their surface modified variants, and combinations thereof. However, it should be appreciated that a skilled artisan may select different oxides and compositions for the overlayer, within the scope of the disclosure.

The overlayer includes an admixture including a graphite-based compound and a transition metal oxide to maintain conductivity, while providing corrosion resistance. The transition metal oxides can interact with any water present on the plate and can prevent localized corrosion even if the graphite-based compound overlayer has a manufacturing defect, such as a pin hole, scratch, or any other defects. Desirably, the heterogenous composition can provide corrosion resistance without requiring additional passivation, thereby creating ease in production. The transition metal oxides provide corrosion resistance because they can react with the water of the coating to prevent localized corrosion. In addition, in cases where the fuel cell experiences high potential, such as greater than 1.4 V, the electrically conductive oxides can electrolyze the water.

Alternatively, bipolar plates that can have a first overlayer and a second overlayer. These overlayers can be applied to a portion of the bipolar plates or the entirety of the bipolar plates. The first overlayer can include a graphite-based compound. The second overlayer can include electrically conductive oxides, such as transition metal oxides. More specifically, the main body include a first overlayer, that can include a graphite-based compound. The graphite-based compounds can include graphite-based oxides, graphene oxides, graphene, and combinations thereof. Desirably, it is believed the graphene can act as a passivation layer, while remaining conductive. It should be appreciated that the other materials may be selected for the first overlayer.

The first overlayer can be coated with the second overlayer. The second overlayer can include electrically conductive oxides. In particular examples, the electrically conductive oxides include a transition metal oxide. The transition metal oxides can include one or more oxides of ruthenium (Ru) and iridium (Ir) and surface modified variants thereof. Examples of transition metal oxides include, but are not limited to, RuIrOₓ (Ru rich), IrRuOₓ (Ir rich), RuOₓ/NbOₓ and IrOₓ/NbOₓ and their surface modified variants, and combinations thereof. It should be appreciated that a skilled artisan may select other electrically conductive oxides, as desired. Desirably, the electrically conductive oxides can permit the second overlayer to have intrinsic chemical, electrochemical and corrosion resistance. This can allow the second overlayer to prevent corrosion from forming in one of the bipolar plates when there is a scratch or defect in the first overlayer of the bipolar plate. In addition, in cases where the fuel cell experiences high potential, such as greater than 1.4 V, the electrically conductive oxides can electrolyze the water.

In some embodiments, a plurality of the graphite-based compound overlayer and the transition metal oxide overlayer are applied to the bipolar plates. The number of overlayers that can be included can be optimized by one of skill in the art. Further, the overlayers can be applied in an alternating order so that no two like layers are adjacent one another. In other words, the graphite-based overlayer alternates with the transition metal oxide overlayer in a repetitive manner until the desired amount of overlayers has been applied. Alternatively, the overlayers can be applied with a plurality of like overlayers applied over one another. In other words, a plurality of either the graphite-based overlayer or the transition metal oxide overlayer can be applied before applying a different overlayer. This can be repeated until the desired amount of overlayers has been applied.

In some embodiments, the overlayer is also applied to different metal components within the fuel cell. Desirably, the overlayer can protect corrosion from forming in these components, while maintaining the conductivity of the metal components. It should be appreciated that a skilled artisan may select different oxides and compositions for the overlayer, within the scope of the disclosure.

Various gaskets can be disposed relative to the bipolar plates and the MEA of the fuel cell. The gaskets can be configured to provide a fluid-tight seal at certain portions of the fuel cell. The gaskets can be manufactured from an elastomer or polymer or any other material suitable for forming a fluid-tight seal. It should be appreciated that a skilled artisan can employ different gaskets, within the scope of this disclosure.

The MEA can include a membrane and electrode layers that include one or more catalysts. The electrode layers (e.g., anode layer and cathode layer) can include one or more identical or different catalysts. The membrane can include a proton exchange membrane (also referred to as a polymer electrolyte membrane), which can include one or more ionomers. The membrane can be configured to conduct protons while acting as an electric insulator and reactant barrier; e.g., preventing passage of oxygen and hydrogen. It should be appreciated that one skilled in the art can select other types of membranes for the membrane, as desired. The membrane can be disposed between two catalyst layers, which can include various materials having one or more catalysts embedded therein. One of skill in the art can select other types of membranes, as desired, to be used in the MEA.

The membrane can be configured as an ion exchange resin membrane. Such ion exchange resins include ionic groups in their polymeric structure, one ionic component of which is fixed or retained by the polymeric matrix and at least one other ionic component is a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cation exchange, proton conductive resins is the so-called sulfonated polymer cation exchange resins. In the sulfonated polymer membranes, the cation ion exchange groups can include hydrated sulfonic acid radicals which are covalently attached to the polymer backbone.

Such ion exchange resins can be formed into membranes or sheets. Examples include sulfonated fluoropolymer electrolytes in which the membrane structure has ion exchange characteristics, and the polymer has a fluorinated backbone structure. Commercial examples of such sulfonated fluorinated, proton conductive membranes include membranes available from E.I. Dupont de Nemours & Co. under the trade designation NAFION. Another such sulfonated fluorinated ion exchange resin is sold by Dow Chemical.

The membrane can be disposed between at least two electrode layers including an anode layer and a cathode layer. The electrode layers can each include one or more types of catalysts, where certain embodiments can include particles of platinum (Pt) disposed on a high-surface-area carbon support (Pt/C). However, other noble group metals can also be used for the catalyst. The Pt/C can be mixed with an ion-conducting polymer (e.g., ionomer) and disposed between the membrane and the gas diffusion layers. The anode layer enables hydrogen molecules to dissociate into protons and electrons. The cathode layer enables oxygen reduction by reacting with the protons generated by the anode, producing water. The ionomer mixed into the catalyst layers can allow the protons to travel through these layers.

While still referring to FIG. 1, the fuel cell can have an anode side and a cathode side. At the anode side, a catalyst can cause the fuel to undergo oxidation reactions that generate ions (e.g., positively charged hydrogen ions) and electrons. The ions can move from the anode to the cathode through the electrolyte. At the same time, electrons can flow from the anode to the cathode through an external circuit, producing direct current electricity. At the cathode side, another catalyst can cause ions, electrons, and oxygen to react, which can form water or other byproducts.

A gas diffusion layer (GDL) can be disposed outside of each of the electrode layers (e.g., anode layer and cathode layer) and can facilitate transport of reactant fluids to the respective electrode layer, as well as facilitate removal of reaction products, such as water. Each of the gas diffusion layers can be compromised of a sheet of carbon paper in which the carbon fibers are partially coated with polytetrafluoroethylene (PTFE). Reactant fluids such as hydrogen gas and oxygen gas or air can diffuse through the pores in the gas diffusion layers. The gas diffusion layer can be coated with a thin layer of high-surface-area carbon mixed with PTFE, which can be referred to as a microporous layer. The microporous layer can be used to tailor a desired balance between water retention (as needed to maintain membrane conductivity) and water removal (as needed to keep pores open so hydrogen and oxygen can diffuse into the respective electrodes). It should be appreciated that a person skilled in the art can select other types of gas diffusion layers, within the scope of this disclosure. It should also be appreciated that the gas diffusion layers can be incorporated into the electrode layers.

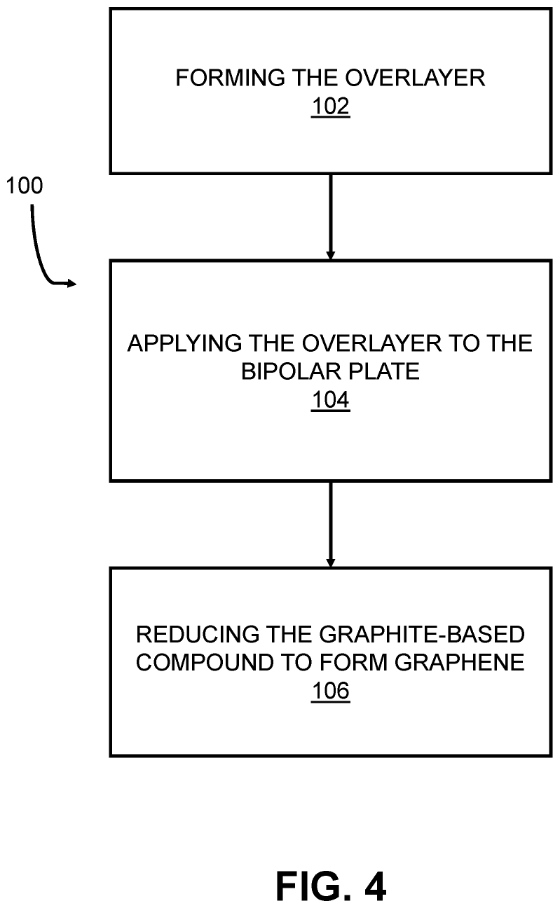

A method of creating bipolar plate of the present disclosure 100 is generally shown in FIG. 4 and can start with forming the overlayer 102 to be applied to a bipolar plate. The bipolar plate can be formed of a metal such as titanium or stainless steel. The bipolar plate can then be coated with an overlayer, without need for passivation. Application of the overlayer to the bipolar plate or formation of the overlayer on the bipolar plate can include where the overlayer is disposed on one or more discrete portions of the bipolar plate (e.g., portions where the bipolar plate confronts an active area of the fuel cell or an electrode of the MEA), or the overlayer can be applied to an entirety of the bipolar plate. The overlayer can be formed as a single layer including a combination of a graphite-based compound, such as graphene and/or graphene oxide, and one or more transition metal oxides.

The overlayer can be formed by dispersing the graphite-based compound and one or more transition metal oxides into a water and alcohol mixture, the concentration of alcohol is dependent on the graphite-based compound and transition metal oxide used, and can be optimized by one skilled in the art. Once the overlayer is created, it can be applied 104 using any one of several techniques, including, but not limited to, ultrasonic spray, chemical vapor deposition, and dip coating techniques. However, it should be appreciated that one skilled in the art may employ other methods of applying the overlayer to the main body of each of the bipolar plates. Next, the graphite-based compound, such as graphene oxide, of the overlayer on the bipolar plate is reduced to form graphene 106, thereby forming a heterogenous composition on the metallic bipolar plate. As mentioned above, the heterogenous composition can have graphene and the transition metal oxide. The resulting overlayer of graphene can include the transition metal oxide(s) embedded or intercalated within layers of graphene.

Alternatively, the overlayer can be formed as two separate layers. The first overlayer is formed by dispersing the graphite-based compound into a water and alcohol mixture, the concentration of alcohol is dependent on the graphite-based compound used, and can be optimized by one skilled in the art. Once the first overlayer is created, it can be applied using any one of several techniques, including, but not limited to, ultrasonic spray, chemical vapor deposition, and dip coating techniques. However, it should be appreciated that one skilled in the art may employ other methods of coating the main body of each of the bipolar plates with the graphite-based oxides. Next, the graphite-based compound first overlayer is reduced to form graphene on the metallic bipolar plate. Then, the second overlayer is formed by dispersing the one or more transition metal oxides into a water and alcohol mixture, the concentration of alcohol is dependent on the transition metal oxide use, and can be optimized by one skilled in the art. Once the second overlayer is formed, it can be applied over the first overlayer using several techniques, including, but not limited to, ultrasonic spray, chemical vapor deposition, and dip coating techniques. However, it should be appreciated that one skilled in the art may employ other methods of coating the main body of each of the bipolar plates with the transition metal oxides.

Advantageously, it is believed without being bound to a particular theory, that the bipolar plates can have increased durability, while remaining conductive, due to the inclusion of the addition components in either a single overlayer or in two separate overlayers. In addition, it is believed that the second overlayer can permit the bipolar plates to have intrinsic chemical, electrochemical, and corrosion resistance.

### Examples

Example embodiments of the present technology are provided with reference to the several figures enclosed herewith.

A fuel cell can include a pair of bipolar plates sandwiching a membrane electrode assembly (MEA), where certain gaskets and/or gas diffusion layers can be provided to optimize reactant distribution and localization. A non-limiting example of the general structure of a fuel cell stack including two fuel cells is shown in FIG. 1. However, it should be appreciated that a skilled artisan can employ fuel cells with different structures, within the scope of this disclosure.

FIG. 1 depicts a PEM fuel cell stack 2 of two fuel cells 3, each fuel cell 3 having a membrane-electrode-assembly (MEA) 4, 6 separated from each other by an electrically conductive fluid distribution element 8, hereinafter also referred to as bipolar plate assembly 10. The MEAs 4, 6 include a membrane-electrolyte layer having an anode and a cathode with a catalyst on opposite faces of the membrane-electrolyte. The MEAs 4, 6 and bipolar plate assembly 8, 10 are stacked together between end plates 12, 14 and end contact elements 16, 18 under compression. The end contact elements 16, 18 and the bipolar plate assembly 8, 10 include working faces 20, 22, 24, 26 respectively, for distributing fuel and oxidant gases (e.g., H₂ and air or O₂) to the MEAs 4, 6. Nonconductive gaskets 28, 30, 32, 34 provide seals and electrical insulation between the several components of the fuel cell stack 2.

Each of the MEAs 4, 6 are disposed between gas permeable conductive materials known as gas diffusion media 36, 38, 40, 42. The gas diffusion media 36, 38, 40, 42 can include carbon or graphite diffusion paper. The gas diffusion media 36, 38, 40, 42 can contact the MEAs 4, 6, with each of the anode and the cathode contacting an associated one of the gas diffusion media 36, 38, 40, 42. The end contact units 16, 18 contact the gas diffusion media 36, 42 respectively. The bipolar plate assembly 8, 10 contacts the gas diffusion media 38 on the anode face of MEA 4 (configured to accept hydrogen-bearing reactant) and also contacts gas diffusion medium 40 on the cathode face of MEA 6 (configured to accept oxygen-bearing reactant). Oxygen can be supplied to the cathode side of the fuel cell stack 2 from storage tank 48, for example, via an appropriate supply conduit 44. Hydrogen can be supplied to the anode side of the fuel cell from a storage tank 50, for example, via an appropriate supply conduit 46. Alternatively, ambient air can be supplied to the cathode side as an oxygen source and hydrogen to the anode from a methanol or gasoline reformer, and the like. Exhaust conduits (not shown) for both the anode and cathode sides of the MEAs 4, 6 are also provided. Additional conduits 52, 54, 56 are provided for supplying a coolant fluid to the bipolar plate assembly 8, 10 and the end contact elements 16, 18. Appropriate conduits for exhausting coolant from the bipolar plate assembly 8, 10 and end contact elements 16, 18 are also provided (not shown).

With reference now to FIG. 2, the bipolar plate assembly 8,10 of one of the fuel cells of the fuel cell stack 2 is shown in greater detail, where an overlayer 58 is coated on the bipolar plate 8, 10. The overlayer 58 can include an admixture containing a graphite-based compound 60 and transition metal oxides 62. Both the graphite-based compound 60 and the transition metal oxides 62 can be included in a single overlayer 58. Alternatively, additional layers of the overlayer containing the admixture of the graphite-based compound and transition metal oxides can be applied over the first overlayer.

With reference to FIG. 3, the bipolar plate assembly 8,10 of one of the fuel cells of the fuel cell stack 2 is shown in greater detail, where there are two overlayers. The first overlayer 64 can include a graphite-based compound 60, which is coated directly on the bipolar plate assembly 8, 10. A second overlayer 66 is applied over the first overlayer 64 and can include transition metal oxides 62.

In another embodiment which is not shown, a plurality of overlayers can be applied to either a portion or the entirety of the bipolar plate assembly. The plurality of overlayers can include alternating overlayers of the graphite-based overlayer and the transition metal oxide overlayer. This application can be repeated until the desired amount of overlayers has be applied. Alternatively, multiple layers of either the graphite-based overlayer or transition metal oxide overlayer can be applied to the bipolar assembly and then the other overlayer can be applied over the plurality of layers. The application of the overlayers can be repeated until the requisite amount of overlayers has been applied.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A bipolar plate comprising:
a metallic main body; and
an overlayer disposed on the metallic main body, the overlayer including a graphite-based compound and a transition metal oxide.

2. The bipolar plate of claim 1, wherein the graphite-based compound includes graphene.

3. The bipolar plate of claim 2, wherein the graphene includes graphene oxide.

4. The bipolar plate of claim 1, wherein the transition metal oxide includes a member selected from a group consisting of ruthenium oxide, iridium oxide, niobium oxide, and combinations thereof.

5. The bipolar plate of claim 1, wherein the transition metal oxide includes a member selected from a group consisting of RuIrOₓ (Ru rich), IrRuOₓ (Ir rich), RuOₓ/NbOₓ, IrOₓ/NbOₓ and combinations thereof.

6. The bipolar plate of claim 1, wherein the overlayer includes an admixture of the graphite-based compound and the transition metal oxide.

7. The bipolar plate of claim 1, wherein the overlayer includes:
a first overlayer disposed on the metallic main body, the first overlayer including the graphite-based compound; and
a second overlayer disposed on the first overlayer, the second overlayer including the transition metal oxide.

8. The bipolar plate of claim 1, wherein the overlayer includes:
a first overlayer disposed on the metallic main body, the first overlayer including the graphite-based compound;
a second overlayer disposed on the first overlayer, the second overlayer including the transition metal oxide; and
a third overlayer disposed on the second overlayer, the third overlayer including the graphite-based compound.

9. The bipolar plate of claim 1, wherein the overlayer includes:
a plurality of first overlayers, one of the first overlayers disposed directly on the metallic main body, the plurality of first overlayers including the graphite-based compound; and
a plurality of second overlayers, each of the second overlayers disposed between two of the first overlayers, the plurality of second overlayers including the transition metal oxide.

10. The bipolar plate of claim 1, wherein:
the metallic main body includes one of stainless steel and titanium;
the graphite-based compound includes graphene oxide;
the transition metal oxide includes a member selected from a group consisting of ruthenium oxide, iridium oxide, niobium oxide, and combinations thereof; and
the overlayer includes an admixture of graphene and the transition metal oxide.

11. The bipolar plate of claim 1, wherein:
the metallic main body includes one of stainless steel and titanium;
the graphite-based compound includes graphene oxide;
the transition metal oxide includes a member selected from a group consisting of ruthenium oxide, iridium oxide, niobium oxide, and combinations thereof; and
the overlayer includes:
a plurality of first overlayers, one of the first overlayers disposed directly on the metallic main body, the plurality of first overlayers including the graphite-based compound; and
a plurality of second overlayers, each of the second overlayers disposed between two first overlayers, the plurality of second overlayers including the transition metal oxide.

12. The bipolar plate of claim 1, wherein:
the metallic main body includes one of stainless steel and titanium;
the transition metal oxide includes a member selected from a group consisting of RuIrOₓ (Ru rich), IrRuOₓ (Ir rich), RuOₓ/NbOₓ, IrOₓ/NbOₓ and combinations thereof; and
the overlayer includes:
a plurality of first overlayers, one of the first overlayers disposed directly on the metallic main body, the plurality of first overlayers including the graphite-based compound; and
a plurality of second overlayers, each of the second overlayers disposed between two first overlayers, the plurality of second overlayers including the transition metal oxide.

13. The bipolar plate of claim 1, wherein the overlayer includes the transition metal oxide in an amount that reduces oxidation-based corrosion of the metallic main body as compared to when the overlayer includes the graphite-based compound but not the transition metal oxide.

14. A fuel cell stack comprising a bipolar plate according to claim 1, wherein the bipolar plate is disposed between two membrane electrode assemblies.

15. A vehicle comprising a fuel cell stack according to claim 14.

16. A method for manufacturing a bipolar plate, comprising:
providing a bipolar plate including a metallic main body; and
disposing an overlayer on the metallic main body, the overlayer including a graphite-based compound and a transition metal oxide.

17. The method of claim 16, wherein disposing the overlayer on the metallic main body includes applying the overlayer to the metallic main body by one of ultrasonic spraying, chemical vapor deposition, and dip coating.

18. The method of claim 16, wherein disposing the overlayer on the metallic main body includes disposing an admixture of the graphite-based compound and the transition metal oxide on the metallic main body.

19. The method of claim 16, wherein disposing the overlayer on the metallic main body includes:
disposing a first overlayer on the metallic main body, the first overlayer including the graphite-based compound;
disposing a second overlayer on the first overlayer, the second overlayer including the transition metal oxide; and
disposing a third overlayer on the second overlayer, the third overlayer including graphene.

20. The method of claim 16, wherein disposing the overlayer on the metallic main body includes:
disposing a plurality of first overlayers on the metallic main body, one of the first overlayers disposed directly on the metallic main body, the plurality of first overlayers including the graphite-based compound; and
disposing a plurality of second overlayers on the metallic main body, each of the second overlayers disposed between two of the first overlayers, the plurality of second overlayers including the transition metal oxide.
